(19) United States
(12) Patent Application Publication
(10) Pub. No.: US 2019/0047723 A1
(43) Pub. Date: Feb. 14, 2019

(54) AIRCRAFT

(71) Applicant: Liebherr-Aerospace Lindenberg GmbH, Lindenberg (DE)

(72) Inventors: Rainer MIELZAREK, Weiler-Simmerberg (DE); Frank KRONBURGER, Lindenberg (DE)

(73) Assignee: Liebherr-Aerospace Lindenberg GmbH, Lindenberg (DE)

(21) Appl. No.: 16/079,175

(22) PCT Filed: Feb. 22, 2017
(86) PCT No.: PCT/EP2017/000251

§ 371 Date: Aug. 23, 2018

(30) Foreign Application Priority Data
Feb. 24, 2016 (DE) 10 2016 002 126.8

(51) Int. Cl. B64D 43/00; B64C 13/50; G06F 13/40; H04L 12/40

(52) U.S. Cl. CPC B64D 43/00; B64C 13/503; H04L 2012/4028; H04L 12/40032; G06F 13/4027

(57) ABSTRACT

The invention relates to an aircraft comprising at least one component and at least one electronic device for controlling the component, wherein the electronic device has at least one interface by means of which signals can be provided for controlling the component, wherein the electronic device has a combination of at least one micro-controller and at least one FPGA core, which are connected to one another via a communication connection, wherein the FPGA core can be configured such that signals can be processed that are each different from one another according to the configuration of the FPGA core.

The present invention relates to an aircraft having at least one component and having at least one electronic device for controlling the component, wherein the electronic device has at least one interface by means of which signals to control the component can be provided.

The use of so-called remote electronic units (REUs) is known from the prior art that have been developed for specific applications to exclusively operate the associated electrical interfaces.

It is disadvantageous here that the electrical interfaces are only compatible with specific types of sensors or analog interfaces or are only capable to control specific drive elements or other components.

The use of one and the same electronic device for different applications is thus only possible with great limitations or is not possible in accordance with the prior art.

It is thus the underlying object of the present invention to further develop an aircraft of the initially named kind such that the electronic device can be used more flexibly than is known from the prior art.

This object is achieved by an aircraft having the features of claim 1. Provision is accordingly made that the electronic device has a combination of at least one microcontroller and at least one FPGA core that are connected to one another by a communication connection, wherein the FPGA core is configurable such that different signals can be processed depending on the configuration of the FPGA core.

The abbreviation FPGA stands for a field programmable gate array.

The use of the electronic device is not fixed to a specific application due to the fact that the FPGA core is configurable or has configurable interfaces. The combined electronic device can rather be configured for controlling a component such as a drive element to the extent that its functionality can be adapted to the component to be controlled and/or to the signals that are provided to the electronic device by e.g. sensors or other interfaces.

The possibility is thus provided of configuring the electrical interfaces of the electronic device as universal in dependence on the application so that different types of sensors or analog interfaces can be evaluated and/or different drive elements can be controlled.

One and the same electronic device can thus be used in different applications.

The electronic device preferably serves the position regulation and control of a drive element of an aircraft such as an actuator and the data concentration of electrical signals that are received from the configurable interfaces.

The electronic device can preferably be attached or integrated in the environment of the component to be controlled, e.g. at the drive element, at flight control surfaces, in the landing gear region of the aircraft, and also in the environment of the control elements of the pilots.

It is pointed out at this point that the term “control” is to be given a broad interpretation and also includes a regulation or monitoring of the component in addition to a control.

The electronic device can be configured flexibly due to its configurability for different applications such as for controlling and regulating a drive element or also for the data concentration of electrical signals that serve the control and monitoring of components of an aircraft.

As initially stated, the electronic device comprises at least one combination of a microcontroller and one or more FPGA cores having a configurable signal association, wherein the two components preferably satisfy the following functions: In a preferred embodiment, the FPGA core has interfaces configurable in dependence on the application for providing signals for further applications of the electronic device and/or for the data concentration and transmission of information to further aircraft computers such as to the actuator control unit, to the flight control computer, etc. via a data bus. The electronic device is thus preferably connected to at least one data bus at the output side or communicates with one or more further computers of the aircraft via a data bus.

In a preferred embodiment, the FPGA core provides integer signals for use in safety-critical systems.

The microcontroller or the microcontroller core preferably serves the carrying out of computation-intensive algorithms using the interface information provided by the FPGA.

In a further embodiment of the invention, the microcontroller core establishes the integrity for safety-relevant signals or device-specific regulation mechanisms and independently carries out selected monitoring functions of, for example, the drive unit of landing gear or a flap of a high lift system.

In a preferred embodiment of the invention, the microcontroller core initiates required checks of the system on the power up and takes over the applications required for maintenance such as the error data memory or also the transmission of the device status via the data bus.

In a preferred embodiment of the invention, the electronic device comprises means for configurable signal association. This means that the number of signals that is supplied to the FPGA core or to the microcontroller core or to both can be configured and adapted via simple placement options.

In a preferred embodiment of the invention, the combined electronic device serves the position regulation and control of a drive element of an aircraft and also the data concentration of electrical signals with configurable interfaces.

As stated above, the electronic device is based on a combination of at least one microcontroller and at least one FPGA core, wherein the FPGA core mainly serves as an I/O (input/output) handler or data concentrator and is correspondingly configurable in dependence on the application. This means that different sensors or other interfaces, i.e. signal sources, can preferably be operated by charging application IP cores in the FPGA at the same electrical connectors in dependence on the application. The signals provided by these interfaces or sensors can, for example, be analog signals, LVDTs, resolvers, discrete signals, etc.

The signals or data transmitted to the electronic device in this manner can, for example, either be transferred on the external digital data bus or can also be provided within the electronic device for position regulation and for the monitoring function. A microcontroller is here responsible for the performance of mathematical algorithms and monitoring functions.

In addition, the electronic device in accordance with the invention is preferably able to satisfy the safety demands typical in aviation for the evaluation of critical signals and to supply them on the data bus. The data bus can be connected to one or more further computers of the aircraft on which the evaluation of the information provided by means of the data bus is carried out.

The microcontroller core can carry out an independent check or also a comparison with respect to the signals supplied to the FPGA core for this purpose. The independent check or comparison can also take place with respect to a redundant signal with respect to the input signal of the FPGA core. The number of signals that can be supplied to the FPGA core and/or to the microcontroller core can be configured as stated above via simple determination options or via corresponding means for configuration.

An advantage of this is that the implementation takes place with small space requirements and the technology can be accommodated locally in a small housing.

The advantages of the invention with respect to the prior art comprise the flexible configurations of the electronic device in dependence on the application. This means that one and the same electronic device can be used for controlling or for regulating a drive element and for the evaluation or for the data concentration of electrical signals that serve the control and monitoring of a flight control system or control elements of the pilot, etc.

The inputs and outputs of the electronic device can be flexibly configured in dependence on the application, from which the flexible possibility of use of the electronic device results.

A weight saving and a reduced cabling effort furthermore results overall at the aircraft as does the advantage of simple servicing by using a single device type for different applications. The combination in accordance with the invention of microcontroller and FPGA enables a universal use.

The use also for safety-critical systems by ensuring the integrity of the safety-relevant signals can be named as a further advantage.

Further details and advantages of the invention will be explained in more detail with reference to an embodiment shown in the drawing.

There are shown:

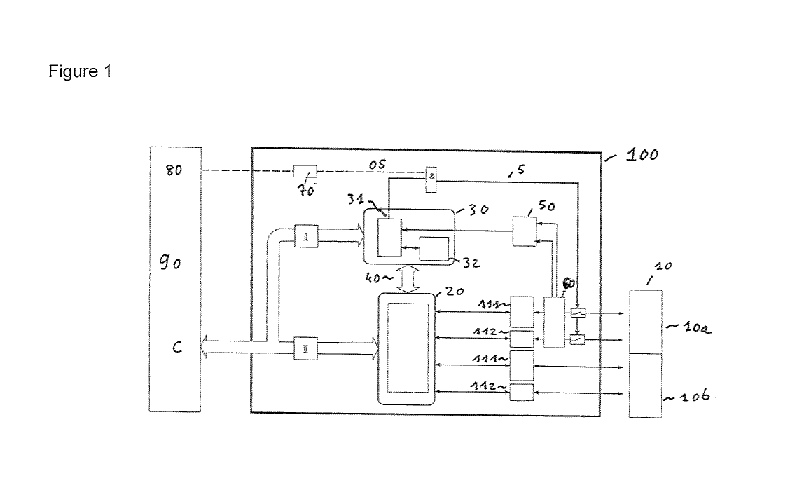

FIG. 1: in a schematic view, an electronic device of an aircraft in accordance with the invention; and

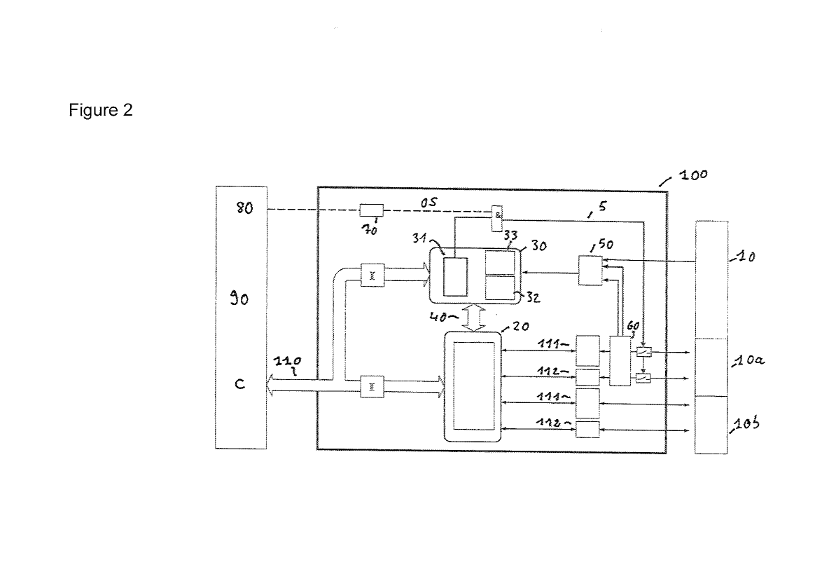

FIG. 2: in a schematic view, an electrical device of an aircraft in accordance with the invention in a further embodiment.

The electronic device is marked by reference numeral 100 in FIG. 1. Reference numeral 10 designates critical and non-critical interfaces or sensors, wherein critical and non-critical interfaces or sensors are arranged in the region 10a and non-critical interfaces or sensors are arranged in the region 10b or their signals are provided therein.

As can further be seen from the Figure, the non-critical signals in accordance with 10b are transferred to discrete in/out and power switches 111 or to the analog input/output 112. The same applies accordingly to the critical and non-critical interfaces or sensors 10a that are likewise transferred to the units 111 and 112, wherein the configurable signal association 60 is arranged between these two components. The electronic device thus preferably has means for the configurable signal association 60 in addition to the microcontroller 30 and the FPGA core or cores 20.

Reference numeral 50 designates analog and discrete inputs that are supplied to the microcontroller or microcontrollers 30.

The FPGA 20 has interfaces configurable in dependence on the application for providing signals for further applications of the electronic device or for the data concentration and transmission of the information to further aircraft computers such as an actuator control unit or a flight control computer via the data bus 110. The corresponding communication is marked by reference symbol C in the Figure. A further object of the FPGA core 20 is the provision of integer signals for a use in safety-critical systems.

The microcontroller core 30 serves the implementation of computation-intensive algorithms using the interface information provided by the FPGA. The unit 32 serves the carrying out of these algorithms and functions. Reference numeral 31 of the microcontroller 30 designates the monitor section.

The microcontroller 30 does not only serve the implementation or the carrying out of computing-intensive algorithms on the basis of the interface information provided by the FPGA 20 via the connection 40, but also the establishing of the integrity for safety-relevant signals or device-specific regulation mechanisms and independently carries out selected monitoring functions, for example a drive unit. The microcontroller core 30 furthermore initiates required checks of the system on power up and takes over the applications required for maintenance.

As already stated above, the unit 60 serves the configuration and adaptation of the number of signals that should be supplied to the FPGA core 20 and to the microcontroller core 30 or to both in combination. This number of the signals can be configured and adapted via simple determination options.

Reference numeral 90 in the Figure denotes an electronic control unit and reference numeral 80 denotes a power down of the electronic unit 100 over the digital input 70. Reference symbol US denotes an optional shut down and reference symbol S denotes a shut down that serves the powering down of the electronic device.

It is possible by the present invention to configure the FPGA e.g. by loading IP (intellectual property) cores such that different interfaces or sensors can be operated or connected at the same electrical connectors or interfaces of the electronic device in dependence on the application, which means that e.g. analog signals, LVDTs (linear variable differential transducers), etc. can be processed.

FIG. 2 shows a further embodiment, wherein elements that are the same or that have the same function are provided with the same reference numerals as in FIG. 1.

The sensor or sensors are directly connected to the microcontroller 30 via analog and discrete inputs 50.

The microcontroller 30 has a configurable data concentrator 33.

The Figures show the use of the device 100 e.g. for controlling an actuator, not shown, wherein the interfaces are configured in a manner such that the actuator can be controlled and monitored by the device 100.

The amplitude and frequency of the excitation voltage required for operating the LVDTs is provided via a universal analog output with a variable voltage and frequency with the aid of a computing process implemented in the FPGA 20. One of the universally usable analog inputs (suitable e.g. for voltage measurement, current measurement, frequency measurement, resistance measurement, . . . ) is correspondingly configured in the FPGA 20 using LVDT-specific evaluation algorithms to read in and evaluate the LVDT signal voltage this is required for determining the LVDT position. The control current required for controlling the servo valves located in the actuator is provided via one of the universally usable analog outputs, wherein the control current is set by the FPGA 20 using application-specific algorithms.

The signals required for this embodiment for ensuring the integrity and monitoring of the actuator are processed via the universally usable analog inputs (suitable e.g. for voltage measurement, current measurement, frequency measurement, resistance measurement, . . . ) of the microcontroller 30 with a specific programming of the evaluation algorithms. In the embodiment, they are LVDT signals and a current measurement of the servo valve control. The control of the mode selector valve shown in the embodiment, that is designed as a solenoid valve, is carried out by means of one of a plurality of discrete outputs and can e.g. be interrupted in the event of a defect at the demand of the microcontroller 30. The signals prepared for operating the actuator are exchanged between the microcontroller 30 and the FPGA 20 over a data bus and are provided as required via an external data bus.

1. An aircraft having at least one component and having at least one electronic device for controlling the component, wherein the electronic device has at least one interface by means of which signals for controlling the component are provided, wherein the electronic device has a combination of at least one microcontroller and at least one FPGA core that communicate with one another via a communication link, with the FPGA core being configurable such that different signals can be processed in dependence on the configuration of the FPGA core, wherein the microcontroller is configured to independently carry out monitoring functions and wherein the microcontroller is configured to initiate checks of the component.

2. The aircraft in accordance with claim 1, wherein the component is a drive element of the aircraft.

3. The aircraft in accordance with claim 1, wherein the FPGA core is configurable by charging application IP cores.

4. The aircraft in accordance with claim 1, wherein the signals that are applied to the interfaces are analog signals, digital signals, LVDTs, resolvers, or discrete signals.

5. The aircraft in accordance with claim 1, wherein the device has at least one output that communicates with a digital data bus, with the output being connected to the microcontroller and to the FPGA core and with the data bus communicating with one or more computers of the aircraft.

6. The aircraft in accordance with claim 1, wherein the FPGA core is configured to concentrate a plurality of data and/or to transfer signals to the microcontroller.

7. The aircraft in accordance with claim 1, wherein the microcontroller is configured to carry out algorithms using the signals provided by the FPGA core.

8. (canceled)

9. (canceled)

10. The aircraft in accordance with claim 1, wherein means for a configurable signal association are present by means of which signals can be supplied to the FPGA core or to the microcontroller.
